(19) United States
(12) Patent Application Publication
(10) Pub. No.: US 2026/0225341 A1
(43) Pub. Date: Aug. 6, 2026

(54) LAMINATED SHEET, AND METHOD FOR PRODUCING SAME

(71) Applicants: LINTEC CORPORATION, Tokyo (JP); MADICO, INC., Pinellas Park, FL (US)

(72) Inventors: Tetsuya ARAZOE, Tokyo (JP); Miki KAMO, Tokyo (JP); Yoichi TAKAHASHI, Tokyo (JP)

(73) Assignees: LINTEC CORPORATION, Tokyo (JP); MADICO, INC., Pinellas Park, FL (US)

(21) Appl. No.: 19/046,988

(22) Filed: Feb. 6, 2025

(51) Int. Cl. B32B 3/26; B23K 15/00; B32B 7/06; B32B 7/12; B32B 15/09

(52) U.S. Cl. CPC B32B 3/266; B23K 15/0006; B32B 7/06; B32B 7/12; B32B 15/09; B32B 2307/737

(57) ABSTRACT

A laminated sheet that includes a base material and a metal layer provided on one surface side of the base material, wherein one or more holes having an area of 0.5 μm² or more when viewed in a plan view are present in the metal layer, and a method of manufacturing the same.

### TECHNICAL FIELD

The present invention relates to a laminated sheet including a metal layer and a method of manufacturing the laminated sheet.

### BACKGROUND ART

Window films are films that are applied to window glasses of buildings and automobiles to provide certain functions to the window glasses. Depending on the configuration and material quality, window films can provide window glasses with adjustability of transmittance for light rays such as visible light, ultraviolet light, and infrared light, scratch resistance, anti-scattering properties, decoration, etc.

In general, window films have a configuration in which a base material such as a resin film is provided with some layers such as a functional layer that exerts the above-described functions and/or a pressure sensitive adhesive layer that serves to adhere to the window glass.

When applying window films to window glasses, a wet application is usually performed by spraying an application liquid (water containing a surfactant) onto one surface of the window film or onto the window glass. By interposing the application liquid between the window film and the window glass, it becomes easy to adjust the application position.

When performing the above wet application, it is necessary to push out the above application liquid using a spatula or the like, and it is further necessary after the application to dry the window film and the window glass for a certain period of time to vaporize the application liquid remaining between the window film and the window glass.

However, when the window film includes a metal layer composed of metal foil, a metal vapor deposition film, or the like, the high water vapor barrier properties of the metal layer may cause insufficient drying.

Patent Document 1 discloses a laminated sheet in which a porous primer layer with pores of 1 to 100 nm in diameter is formed on a base material, and a metal layer with many pores is then provided by sputtering a metal on the porous primer layer. The laminated sheet aims to achieve a certain level of water drainage properties by providing the metal layer with pores.

### PRIOR ART DOCUMENTS

### Patent Documents

[Patent Document 1] Japanese translation of PCT international application, No. 2000-504645

### SUMMARY OF THE INVENTION

### Problems to be Solved by the Invention

However, even the laminated sheet disclosed in Patent Document 1 has insufficient water drainage properties when applied by wet application, and a laminated sheet with better water drainage properties is desired.

The present invention has been made in consideration of such circumstances, and an object of the present invention is to provide a laminated sheet that exhibits excellent water drainage properties and a method of manufacturing the same.

### Means for Solving the Problems

To achieve the above object, first, the present invention provides a laminated sheet comprising a base material and a metal layer provided on one surface side of the base material, wherein one or more holes having an area of 0.5 μm² or more when viewed in a plan view are present in the metal layer (Invention 1).

In the above invention (Invention 1), the area may be preferably 10 μm² or less (Invention 2).

In the above invention or inventions (Inventions 1 and 2), the one or more holes may preferably have an irregular shape when viewed in the plan view (Invention 3).

In the above invention or inventions (Inventions 1 to 3), the number of the one or more holes may be preferably one or more per an area of 150 μm-220 μm of the metal layer (Invention 4).

In the above invention or inventions (Inventions 1 to 4), preferably, two or more of the holes may be present in the metal layer, and an average value of a distance between adjacent two of the holes may be 1 μm or more and 200 μm or less (Invention 5).

In the above invention or inventions (Inventions 1 to 5), preferably, three or more of the holes may be present in the metal layer, and an average value of a radius of a perfect circle passing through adjacent three of the holes may be 1 μm or more and 100 μm or less (Invention 6).

In the above invention or inventions (Inventions 1 to 6), preferably, provided that: the number of the one or more holes present in the metal layer is n (n: integer, n≥4); any one of the n holes is selected and defined as a first hole; a triangle with vertices of the first hole, a hole closest to the first hole, and a hole second closest to the first hole is defined as a first triangle; and out of a triangle with vertices of the first hole, the hole closest to the first hole, and a hole third closest to the first hole and a triangle with vertices of the first hole, the hole second closest to the first hole, and the hole third closest to the first hole, one having a smaller area is defined as a second triangle, when: distance (C1) between a centroid point of the first triangle and a centroid point of the second triangle is measured; then, any one hole among the n holes excluding the first hole is selected and defined as a second hole, and after the distance already measured between the centroid point of the first triangle and the centroid point of the second triangle is excluded, a distance (C2) between a centroid point of a first triangle and a centroid point of a second triangle that are obtained using the second hole as a starting point is measured like the distance (C1); and the measurement is further performed for the n distances (C1, C2, . . . , Cn), an average value of the n distances (C1, C2, . . . , Cn) may be 1 μm or more and 100 μm or less (Invention 7).

In the above invention or inventions (Inventions 1 to 7), preferably, provided that: the number of the one or more holes present in the metal layer is n (n: integer, n≥4); any one of the n holes is selected and defined as a first hole; a perfect circle passing through the first hole, a hole closest to the first hole, and a hole second closest to the first hole is defined as a first perfect circle; and for a hole that is not concentric with the first perfect circle and is third closest to the first hole, out of a perfect circle passing through the first hole, the hole closest to the first hole, and the hole third closest to the first hole and a perfect circle passing through the first hole, the hole second closest to the first hole, and the hole third closest to the first hole, one having a smaller area is defined as a second perfect circle, when: a distance (D1) between a center of the first perfect circle and a center of the second perfect circle is measured; then, any one hole among the n holes excluding the first hole is selected and defined as a second hole, and after the distance already measured between the center of the first perfect circle and the center of the second perfect circle is excluded, a distance (D2) between a center of a first perfect circle and a center of a second perfect circle that are obtained using the second hole as a starting point is measured like the distance (D1); and the measurement is further performed for the n distances (D1, D2, . . . , Dn), an average value of the n distances (D1, D2, . . . , Dn) may be 1 μm or more and 400 μm or less (Invention 8).

In the above invention or inventions (Inventions 1 to 8), the laminated sheet may preferably include a pressure sensitive adhesive layer (Invention 9).

In the above invention or inventions (Inventions 1 to 9), the laminated sheet may be preferably a window film (Invention 9).

Second, the present invention provides a method of manufacturing the laminated sheet (Inventions 1 to 10), comprising: a step of irradiating a metal with an electron beam to vaporize the metal; and a step of depositing the vaporized metal on one surface side of the base material to form the metal film (Invention 11).

### Advantageous Effect of the Invention

The laminated sheet according to the present invention exhibits excellent water drainage properties. Moreover, the manufacturing method according to the present invention provides a method of manufacturing the laminated sheet.

### BRIEF DESCRIPTION OF THE DRAWINGS

FIG. 1 is a set of cross-sectional views illustrating examples of the layer configurations of laminated sheets according to one or more embodiments of the present invention.

### EMBODIMENTS FOR CARRYING OUT THE INVENTION

Hereinafter, one or more embodiments of the present invention will be described.

The laminated sheet according to the present embodiment includes a base material and a metal layer provided on one surface side of the base material. In the laminated sheet according to the present embodiment, one or more holes having an area of 0.5 μm² or more when viewed in a plan view are present in the metal layer.

The laminated sheet according to the present embodiment includes a metal layer and can thereby exhibit excellent light blocking properties. In particular, when the laminated sheet according to the present embodiment is used as a window film, it is possible to satisfactorily adjust the transmittance for light rays such as visible light, ultraviolet light, and infrared light.

Moreover, even though the laminated sheet according to the present embodiment includes a metal layer, the presence of holes in the metal layer that satisfy the above area condition allows the laminated sheet according to the present embodiment to exhibit excellent water drainage properties even when the laminated sheet according to the present embodiment is applied to an object by wet application. As a result, it is possible to prevent problems such as delamination of the laminated sheet due to application liquid remaining between the laminated sheet and the object to which it is applied.

### 1. Holes

### (1) Area of Holes

As described above, in the laminated sheet according to the present embodiment, one or more holes having an area of 0.5 μm² or more when viewed in a plan view are present in the metal layer, but from the viewpoint of readily exhibiting more excellent water drainage properties, the area of the holes may be preferably 0.8 μm² or more, more preferably 1.2 μm² or more, particularly preferably 1.5 μm² or more, and further preferably 1.8 μm, or more.

Additionally or alternatively, from the viewpoint of readily exhibiting more excellent light blocking properties, the area of the holes may be preferably 10 μm² or less, more preferably 7 μm² or less, particularly preferably 5 μm² or less, further preferably 4 μm² or less, especially preferably 3 μm² or less, and even more especially preferably 2 μm² or less.

Details of the method of measuring the area of the holes are as described in the testing example, which will be described later. In the laminated sheet according to the present embodiment, holes that do not satisfy the above-described area condition may be present together with holes that satisfy the area condition, and in particular, holes having an area of less than 0.5 μm² when viewed in a plan view may be present.

### (2) Shape of Holes

In the laminated sheet according to the present embodiment, the shape of the holes when viewed in a plan view is not particularly limited, and may be a regular shape or may also be an irregular shape. From the viewpoint of readily exhibiting better water drainage properties and light blocking properties, it is preferred that the shape of the holes be an irregular shape.

### (3) Number of Holes

In the laminated sheet according to the present embodiment, from the viewpoint of readily exhibiting better water drainage properties, the number of holes that satisfy the above-described area condition may be preferably 3 or more per an area of 150 μm×220 μm of the metal layer, more preferably 2 or more, particularly preferably 4 or more, further preferably 6 or more, and especially preferably 8 or more.

On the other hand, from the viewpoint of readily exhibiting more excellent light blocking properties, the number of holes that satisfy the above-described area condition may be preferably 1,000 or less per an area of 150 μm×220 μm of the metal layer, more preferably 500 or less, particularly preferably 200 or less, further preferably 100 or less, especially preferably 50 or less, and even more especially preferably 20 or less.

### (4) Distribution of Holes

### (4-1) Distance Between Two Adjacent Holes

In the laminated sheet according to the present embodiment, when there are two or more holes in the metal layer that satisfy the above-described area condition, it is preferred that the following condition be satisfied.

First, when the number of holes to be measured is n (n: integer, n≥2), any one of the n holes is selected and defined as a first hole. Then, a distance (A1-1) between the first hole and a hole closest to the first hole and a distance (A1-2) between the first hole and a hole second closest to the first hole are measured. Next, any one hole other than the aforementioned first hole among the n holes is selected and defined as a second hole. Then, after excluding between the holes that have already been measured, a distance (A2-1) between the second hole and a hole closest to the second hole and a distance (A2-2) between the second hole and a hole second closest to the second hole are measured. This operation is performed for n holes (A1-1, A1-2, A2-1, A2-2, . . . , An-1, An-2). Note that the distance between holes is the distance between the centroid points of the holes.

The average value of the distance between two adjacent holes measured as above may be preferably 1 μm or more and 200 μm or less. This allows more excellent water drainage properties to be readily exhibited. From this viewpoint, the average value of the above distance may be preferably 5 to 150 μm, more preferably 10 to 120 μm, particularly preferably 15 to 100 μm, further preferably 20 to 80 μm, especially preferably 25 to 60 μm, and even more especially preferably 30 to 50 μm.

### (4-2) Radius of Perfect Circle Passing Through Three Adjacent Holes

In the laminated sheet according to the present embodiment, when there are three or more holes in the metal layer that satisfy the above-described area condition, it is preferred that the following condition be satisfied.

First, when the number of holes to be measured is n (n: integer, n≥3), any one of the n holes is selected and defined as a first hole. Then, “a perfect circle passing through the first hole, a hole closest to the first hole, and a hole second closest to the first hole” is defined as a first perfect circle, and a radius (B1) of the first perfect circle is measured. Next, any one hole among the n holes excluding the aforementioned first hole is selected and defined as a second hole. Then, after excluding the perfect circle that has already been measured, “a perfect circle passing through the second hole, a hole closest to the second hole, and a hole second closest to the second hole” is defined as a second perfect circle, and a radius (B2) of the second perfect circle is measured. This operation is performed for n holes (B1, B2, . . . , Bn). Note that the perfect circle passes through the centroid point of each hole.

The average value of the radius of the perfect circle passing through three adjacent holes measured as above may be preferably 1 μm or more and 100 μm or less. By the average value of the radius of the above perfect circle satisfying the above range, more excellent water drainage properties can be readily exhibited. From this viewpoint, the average value of the radius of the above perfect circle may be preferably 5 to 85 μm, more preferably 10 to 70 μm, particularly preferably 15 to 60 μm, further preferably 20 to 50 μm, and especially preferably 25 to 45 μm.

If the holes are arranged in a straight line and a perfect circle passing through those holes cannot be envisioned, the radius of the perfect circle for the hole is not evaluated.

### (4-3) Distance Between Centroids of Two Triangles Formed of Four Points

In the laminated sheet according to the present embodiment, when there are four or more holes in the metal layer that satisfy the above-described area condition, it is preferred that the following condition be satisfied.

First, when the number of holes to be measured is n (n: integer, n≥4), any one of the n holes is selected and defined as a first hole. Then, “a triangle with vertices of the first hole, a hole closest to the first hole, and a hole second closest to the first hole” is defined as a first triangle. Out of “a triangle with vertices of the first hole, the hole closest to the first hole, and a hole third closest to the first hole” and “a triangle with vertices of the first hole, the hole second closest to the first hole, and the hole third closest to the first hole,” one having a smaller area is defined as a second triangle. If the areas are the same, the former is defined as the second triangle. Then, a distance (C1) between the centroid point of the first triangle and the centroid point of the second triangle is measured. Next, any one hole among the n holes excluding the aforementioned first hole is selected and defined as a second hole. Then, after the distance already measured between the centroid point of the first triangle and the centroid point of the second triangle is excluded, a distance (C2) between the centroid point of a first triangle and the centroid point of a second triangle that are obtained using the second hole as a starting point is measured like the distance (C1). This operation is performed for n holes (C1, C2, . . . , Cn). Note that each vertex of a triangle is the centroid point of each hole.

The average value of the distance between the vertices measured as above may be preferably 1 μm or more and 100 μm or less. This allows more excellent water drainage properties to be readily exhibited. From this viewpoint, the average value of the distance between the above vertices may be preferably 5 to 75 μm, more preferably 10 to 50 μm, particularly preferably 15 to 40 μm, further preferably 18 to 36 μm, and especially preferably 22 to 32 μm.

If either the first triangle or the second triangle cannot be envisioned due to the holes being arranged in a straight line, the distance between the centroids of the two triangles for the first hole is not evaluated.

### (4-4) Distance Between Centers of Two Perfect Circles Formed of Four Points

In the laminated sheet according to the present embodiment, when there are four or more holes in the metal layer that satisfy the above-described area condition, it is preferred that the following condition be satisfied.

First, when the number of holes to be measured is n (n: integer, n≥4), any one of the n holes is selected and defined as a first hole. Then, “a perfect circle passing through the first hole, a hole closest to the first hole, and a hole second closest to the first hole” is defined as a first perfect circle. For a hole that is not concentric with the first perfect circle and is third closest to the first hole, out of “a perfect circle passing through the first hole, the hole closest to the first hole, and the hole third closest to the first hole” and “a perfect circle passing through the first hole, the hole second closest to the first hole, and the hole third closest to the first hole,” one having a smaller area is defined as a second perfect circle. If the areas are the same, the former is defined as the second perfect circle. Then, a distance (D1) between the center of the first perfect circle and the center of the second perfect circle is measured. Next, any one hole among the n holes excluding the aforementioned first hole is selected and defined as a second hole. Then, after the distance already measured between the center of the first perfect circle and the center of the second perfect circle is excluded, a distance (D2) between the center of a first perfect circle and the center of a second perfect circle that are obtained using the second hole as a starting point is measured in the same manner as above. The operation is performed for the n distances (D1, D2, . . . , Dn). The perfect circle passes through the centroid point of each hole.

The average value of the distance between centers measured as above may be preferably 1 μm or more and 400 μm or less. This allows more excellent water drainage properties to be readily exhibited. From this viewpoint, the average value of the above distance between centers may be preferably 10 to 300 μm, more preferably 25 to 250 μm, particularly preferably 50 to 200 μm, further preferably 75 to 150 μm, and especially preferably 100 to 120 μm.

If either the first triangle or the second triangle cannot be envisioned due to the holes being arranged in a straight line, the distance between the centers of two perfect circles for the first hole is not evaluated.

### 2. Configuration of Laminated Sheet

### (1) Base Material

The base material in the present embodiment is not particularly limited, provided that it is in a sheet form, but it may be preferably transparent to visible light. From this viewpoint, the base material may be preferably a resin film.

Examples of resins constituting the resin film include: polyester-based resins such as polyethylene terephthalate, polybutylene terephthalate, and polyethylene naphthalate; polyolefin-based resins such as polyethylerie, polypropylene, polybutene, polybutadiene, polymethylpentene, ethylene-norborrene copolymer, and norbornene resin; ethylene-vinyl acetate copolymer; ethylene--based copolymer resins such as ethylene-(meth)acrylic acid copolymer, ethylene-methyl(meth) acrylate copolymer, and other ethylene-(meth)acrylic ester copolymers; polyvinyl chloride-based resins such as polyvinyl chloride and vinyl chloride copolymers; (meth)acrylic ester copolymers; polyurethane; polyimide; polystyrene; polycarbonate; and fluorine resins. The resins constituting the base material may be those obtained by crosslinking the above--described resins or those obtained by modifying the above-described resins, such as ionomers of the above-described resins. As used in the present specification, the term “(meth)acrylic acid” refers to both the acrylic acid and the methacrylic acid. The same applies to other similar terms. As used in the present specification, the term “polymer” encompasses the concept of a “copolymer.”

The base material in the present embodiment may be a single layer film composed of the above-described resin, or may also be a laminated film configured such that two or more layers of such films are laminated. In this laminated film, the material constituting each layer may be the same or different. From the viewpoint of the SDGs, a material with a high biomass content, a material that can be recycled or reused, or a recycled or reused material may be used as the material constituting the base material in the present embodiment.

The base material may also contain various additives such as flame retardants, plasticizers, antistatics, glidants, antioxidants, colorants, infrared absorbers, ultraviolet absorbers, and ion scavengers. The content of these additives is not particularly limited, but may be preferably within a range in which the base material exhibits the desired functions.

The thickness of the base material can be set appropriately depending on the use application of the laminated sheet, but may be preferably 10 to 200 μm and particularly preferably 20 to 150 μm.

### (2) Metal Layer

The metal layer in the present embodiment is not limited in the specific configuration, provided that it has holes that satisfy the above-described condition. For example, it may be a vapor-deposited film formed by depositing a metal onto a base material or may also be metal foil laminated on the base material. From the viewpoint of efficiently forming holes that satisfy the above-described condition, the metal layer may be preferably a vapor-deposited film formed by depositing a metal onto a base material.

The metal that constitutes the metal layer according to the present embodiment is not particularly limited, provided that the metal layer has holes that satisfy the above-described condition. However, from the viewpoint of efficiently forming the holes, the above metal may be preferably at least one selected from nickel, aluminum, indium, gold, silver, chromium, germanium, silicon, tin, titanium, copper, niobium, platinum, etc., and nickel may be particularly preferred.

The thickness of the metal layer in the present embodiment is set appropriately depending on the method of forming the metal layer, etc., but may be preferably 1 to 500 nm, more preferably 5 to 350 nm, particularly preferably 10 to 200 nm, further preferably 15 to 100 nm, and especially preferably 20 to 50 nm.

### (3) Pressure Sensitive Adhesive Layer

The laminated sheet according to the present embodiment may also preferably include a pressure sensitive adhesive layer. In this case, the pressure sensitive adhesive layer may be preferably present on the surface of the laminated sheet on the side of an object to which the laminated sheet is applied. This allows the laminated sheet applied to the object to adhere sufficiently to the object, and delamination or displacement after the application can be readily suppressed.

The pressure sensitive adhesive constituting the pressure sensitive adhesive layer can be appropriately selected according to the desired performance. For example, acrylic-based pressure sensitive adhesives, rubber-based pressure sensitive adhesives, silicone-based pressure sensitive adhesives, urethane-based pressure sensitive adhesives, polyester-based pressure sensitive adhesives, polyvinyl ether-based pressure sensitive adhesives, etc. can be used. Among these, acrylic-based pressure sensitive adhesives may be preferably used because they can readily exhibit satisfactory pressure sensitive adhesive properties and optical properties.

The acrylic-based pressure sensitive adhesive may be one that has active energy ray curing properties or may also be one that has non-active energy ray curing properties. The pressure sensitive adhesive composition for forming the acrylic-based pressure sensitive adhesive may be one that requires a solvent to form the pressure sensitive adhesive layer or may also be one that does not require a solvent. An example of a suitable acrylic-based pressure sensitive adhesive may be one that is formed using a pressure sensitive adhesive composition that contains a (meth)acrylic ester copolymer and a crosslinker. The pressure sensitive adhesive composition may further contain a silane coupling agent, an ultraviolet absorber, an infrared absorber, a colorant, a light diffusing agent, an antirust agent, a light stabilizer, an oxygen absorber, an antistatic, etc.

The thickness of the pressure sensitive adhesive layer is not particularly limited, and may be, for example, preferably 1 to 1,000 μm, more preferably 4 to 600 prn, particularly preferably 8 to 300 μm, further preferably 12 to 100 μm, especially preferably 15 to 50 μm, and even more especially preferably 15 to 30 μm.

The positional relationship between the pressure sensitive adhesive layer, the base material, and the metal layer may be, for example, one in which the base material, the metal layer, and the pressure sensitive adhesive layer are laminated in this order, or one in which the metal layer, the base material, and the pressure sensitive adhesive layer are laminated in this order. The pressure sensitive adhesive layer may also be laminated between the base material and the metal layer.

### (4) Other Configurations

The laminated sheet according to the present embodiment may include one or more members other than the base material, metal layer, and pressure sensitive adhesive layer.

For example, when the laminated sheet according to the present embodiment includes a pressure sensitive adhesive layer, a release sheet may be preferably laminated on the exposed surface (pressure sensitive adhesive surface) of the pressure sensitive adhesive layer for the purpose of protecting the exposed surface until it is attached to an object.

The release sheet may have any configuration, and examples include those in which a resin film is subjected to release treatment using a release agent or the like. Specific examples of resin films include polyester films such as polyethylene terephthalate, polybutylene terephthalate, and polyethylene naphthalate, and polyolefin films such as polypropylene and polyethylene. The above release agent for use may be a silicone-based, fluorine-based, long-chain alkyl, or rubber-based agent, among which a silicone-based agent may be preferred because it is inexpensive and provides stable performance. From the viewpoint of the SDGs, a material with a high biomass content, a material that can be recycled or reused, or a recycled or reused material may be used as the material constituting the release sheet.

The thickness of the release sheet is not particularly limited, and it may be, for example, 10 to 250 μm.

The laminated sheet according to the present embodiment may include a desired functional layer at any position. Examples of the functions of the functional layer include hard coat properties, self-repair properties, anti-glare properties, fingerprint resistance, UV shielding properties, infrared shielding properties, slipperiness, anti-fogging properties, antistatic properties, anti-Newton ring properties, anti-reflection properties, high transparency, and crime-prevention properties. The above functional layer may have a plurality of these functions. In particular, from the viewpoint of imparting scratch resistance, a functional layer exhibiting hard coat properties (hard coat layer) may be preferably present on the surface of the laminated sheet opposite to the side of an object to which the laminated sheet is applied.

The material constituting the hard coat layer is not limited, provided that it can achieve the desired hard coat properties, and general materials such as curable resins and fillers can be used as appropriate.

The thickness of the functional layer is set appropriately depending on the intended function. When the functional layer is a hard coat layer, the thickness may be preferably 0.1 to 50 μm, more preferably 0.5 to 30 μm, particularly preferably 1 to 20 μm, and further preferably 2 to 10 μm.

### (5) Examples of Layer Configurations

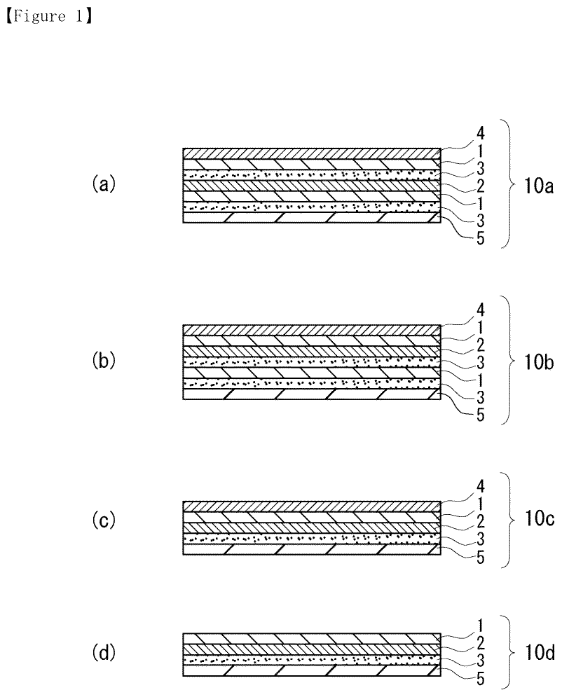

FIG. 1 illustrates examples of the layer configurations of the laminated sheets according to the present embodiment. Note, however, that the layer configurations of the laminated sheets according to the present embodiment are not limited to those illustrated in FIG. 1.

The laminated sheet 10a illustrated in FIG. 1(a) has a layer configuration in which a hard coat layer 4, a base material 1, a pressure sensitive adhesive layer 3, a metal layer 2, a base material 1, a pressure sensitive adhesive layer 3, and a release sheet 5 are laminated in this order. The laminated sheet 10a can impart light blocking properties due to the metal layer 2, as well, as scratch resistance due to the hard coat layer 4, to the window glass as an object, etc.

The laminated sheet 10b illustrated in FIG. 1(b) has a layer configuration in which a hard coat layer 4, a base material 1, a metal layer 2, a pressure sensitive adhesive layer 3, a base material 1, a pressure sensitive adhesive layer 3, and a release sheet 5 are laminated in this order. The laminated sheet 10b can impart light blocking properties due to the metal layer 2, as well as scratch resistance due to the hard coat layer 4, to the window glass as an object, etc.

The laminated sheet 10c illustrated in FIG. 1(c) has a layer configuration in which a hard coat layer 4, a base material 1, a metal layer 2, a pressure sensitive adhesive layer 3, and a release sheet 5 are laminated in this order. The laminated sheet 10c can impart light blocking properties due to the metal layer 2, as well as scratch resistance due to the hard coat layer 4, to the window glass as an object, etc.

The laminated sheet 10d illustrated in FIG. 1(d) has a layer configuration in which a base material 1, a metal layer 2, a pressure sensitive adhesive layer 3, and a release sheet 5 are laminated in this order. The laminated sheet 10d can impart light blocking properties due to the metal layer 2 to the window glass as an object, etc.

### 3. Physical Properties of Laminated Sheet

In the laminated sheet according to the present embodiment, the water vapor transmission rate measured according to JIS Z0208-1976 may be preferably 10 g/m²·day or more, more preferably 15 g/m·day or more, particularly preferably 20 g/m²·day or more, further preferably 24 g/m²·day or more, and especially preferably 28 g/m²·day or more. The laminated sheet according to the present embodiment can readily exhibit the above water vapor transmission rate due to the presence of holes in the metal layer that satisfy the aforementioned condition. The above water vapor transmission rate allows the excellent water drainage properties to be readily achieved. The upper limit of the water vapor transmission rate is not particularly limited, and may be, for example, 1,000 g/m²·day or less in an embodiment, 500 g/m²·day or less in another embodiment, 100 g/m²·day or less in still another embodiment, or 50 g/m²·day or less in yet another embodiment. When the laminated sheet according to the present embodiment includes a release sheet, the above water vapor transmission rate is measured in a state in which the release sheet is removed. Details of the method of measuring the water vapor transmission rate are as described in the testing example, which will be described later.

### 4. Method of Manufacturing Laminated Sheet

The method of manufacturing the laminated sheet according to the present embodiment is not particularly limited, provided that it can form holes that satisfy the aforementioned condition. As described previously, the laminated sheet according to the present embodiment may be manufactured by laminating a metal film composed of metal foil on the base material. However, from the viewpoint of efficiently forming holes that satisfy the aforementioned condition, it is preferred to form the metal layer by vapor-depositing a metal on the base material.

When forming the metal layer by vapor deposition, it is preferred to form the metal layer by an electron beam vapor deposition method from the viewpoint that the above holes can readily be particularly efficiently formed. That is, the laminated sheet according to the present embodiment may be preferably manufactured by a method that includes a step of irradiating a metal with an electron beam to vaporize the metal and a step of depositing the vaporized metal on one surface side of a base material to form the metal film. The present inventors have found that when a metal layer is formed by such an electron beam vapor deposition method (in particular, when nickel is used as the target), it becomes easier to form holes that satisfy the aforementioned condition.

The electron beam vapor deposition method refers to a method in which a small piece of metal or nonmetal (which may be referred to as a “target,” hereinafter) is irradiated with an electron beam in a high vacuum to heat and vaporize the target, and the vaporized target atoms or molecules are allowed to cohere and adhere as a thin film onto the surface of an adherend. The electron beam vapor deposition method for manufacturing the laminated sheet according to the present embodiment is not particularly limited, and it can be performed by a commonly-used scheme.

As conditions for the electron beam vapor deposition method, the degree of vacuum may be preferably 1×10⁻¹ Pa or less, more preferably 8×10⁻² Pa or less, particularly preferably 6×10⁻² Pa or less, and further preferably 5×10⁻² Pa or less. The lower limit of the degree of vacuum is not particularly limited, and may be, for example, 1×10⁻⁴ Pa or more in an embodiment, 1×10⁻³ Pa or more in another embodiment, or 1×10⁻² Pa or more in still another embodiment.

The temperature of a deposition machine drum that contacts the base material which is an adherend may be preferably 50° C. or lower, more preferably 30° C. or lower, particularly preferably 15° C. or lower, and further preferably 0° C. or lower. The lower limit of the temperature of the deposition machine drum is not particularly limited, and may be, for example, −50° C. or higher in an embodiment, −30° C. or higher in another embodiment, or −15° C. or higher in still another embodiment.

The deposition rate in the electron beam vapor deposition method may be preferably 50 nm/min or more, more preferably 100 nm/min or more, and further preferably 500 nm/min or more. The upper limit of the deposition rate is not particularly limited, and may be, for example, 100,000 nm/min or less in an embodiment or 10,000 nm/min or less in another embodiment.

When the laminated sheet according to the present embodiment includes other members such as a pressure sensitive adhesive layer, these members may be appropriately laminated on the metal layer formed as described above or on the base material.

5. Method of using Laminated Sheet

Although the method of using the laminated sheet according to the present embodiment is not particularly limited, it is preferred to apply it to an object that requires light blocking properties. In particular, the laminated sheet according to the present embodiment may be suitably used as a window film. In this case, the laminated sheet according to the present embodiment may be applied to the window glass of a building, an automobile, etc. In addition to window glass, it can also be used as various optical members, in particular optical members constituting screens and displays, or as protective members for them. Furthermore, it can also be used for protecting the components and coatings of various electronic devices (such as personal computers, smartphones, and tablets) and electrical appliances, protecting casings, protecting coatings on the exterior of moving objects such as automobiles, protecting transparent members, etc.

As described above, when applying to window glass, it is preferred to perform wet application. That is, it is preferred to spray the application liquid (water containing a surfactant) onto the laminated sheet or the window glass and apply the laminated sheet while adjusting its position. After application, it is preferred to push out the application liquid remaining between the laminated sheet and the window glass from the edge portion of the laminated sheet using a spatula or the like, and furthermore, it is preferred to leave it for a certain period of time to dry the application liquid.

As described previously, the laminated sheet according to the present embodiment exhibits excellent water drainage properties due to the presence of holes in the metal layer. Thus, according to the laminated sheet of the present embodiment, it is possible to dry the application liquid in wet application in a shorter time and more reliably. As a result, it is possible to suppress delamination and displacement of the laminated sheet from the window glass.

In the present specification, unless otherwise specified, the statement of “X to Y” (X and Y are arbitrary numbers) encompasses not only the meaning of “X or more and Y or less” but also the meaning of “preferably more than X” or “preferably less than Y.” In addition, unless otherwise specified, the statement of “X or more” (X is an arbitrary number) encompasses the meaning of “preferably more than X,” and the statement of “Y or less” (Y is an arbitrary number) encompasses the meaning of “preferably less than Y.”

It should be appreciated that the aforementioned embodiments are described to facilitate understanding of the present invention and are not described to limit the present invention. It is therefore intended that the elements disclosed in the above embodiments include all design changes and equivalents to fall within the technical scope of the present invention.

### EXAMPLES

The present invention will be described in more detail below with reference to examples, etc., but the scope of the present invention is not limited to these examples, etc.

### Example 1

### (1) Formation of Metal Layer

A metal layer was formed by vapor-depositing nickel on one surface of a polyethylene terephthalate film (available from Toray Industries, Inc., product name “Lumirror T60,” thickness: 25 μm) as a base material using an electron beam vapor deposition method.

Specifically, using a vacuum vapor deposition device equipped with a film running device, the above base material was placed on the deposition machine drum, nickel was placed as a target, and the target was irradiated with an electron beam to form a metal layer (thickness: 20 nm) on the surface of the base material in a state in which the degree of vacuum was set to 0.04 Pa and a temperature of the deposition machine drum was set to −10° C.

### (2) Formation of Pressure Sensitive Adhesive Layer

Solution polymerization method was used to polymerize 44.9 mass parts of n-butyl acrylate, 44 mass parts of isobutyl acrylate, 5 mass parts of vinyl acetate, 0.1 mass parts of methacrylic acid, and 6 mass parts of 2-hydroxyethyl methacrylate to obtain a (meth)acrylic ester copolymer. The weight-average molecular weight of the (meth)acrylic ester copolymer was measured and found to be 500,000.

A pressure sensitive adhesive composition was obtained by mixing 100 mass parts (solid content equivalent, here and hereinafter) of the obtained (meth)acrylic ester copolymer and 0.9 mass parts of an isocyanate-based crosslinker (available from Mitsui Chemicals, Inc., product name “TAKENATE D-101E”) in toluene as a solvent.

The obtained pressure sensitive adhesive composition was applied to the surface on the metal layer side of the laminate of the base material and metal layer obtained in the above step (1) and dried to form a pressure sensitive adhesive layer with a thickness of 15 μm. Furthermore, the release layer surface of a release sheet having a silicone-based release layer was attached to the surface of the pressure sensitive adhesive layer opposite to the metal layer.

Thus, a laminated sheet was obtained in which the base material, the metal layer, the pressure sensitive adhesive layer, and the release sheet were laminated in this order.

### Comparative Example 1

A metal layer was formed by vapor-depositing nichrome on one surface of a polyethylene terephthalate film (available from Toray Industries, Inc., product name “Lumirror T60,” thickness: 25 μm) as a base material using a sputtering method.

Specifically, using a vacuum vapor deposition device equipped with a film running device, nichrome was placed as a target, argon gas was Introduced into the chamber, and the device was then operated to form a metal layer (thickness: 20 nm) composed of nichrome on the surface of the base material.

A pressure sensitive adhesive layer and a release sheet were laminated on the laminate thus obtained of the base material and metal layer in the same manner as in Example 1 to obtain a laminated sheet in which the base material, the metal layer, the pressure sensitive adhesive layer, and the release sheet were laminated in this order.

### Comparative Example 2

A laminated sheet was obtained in the same manner as in Comparative Example 1 except that nickel was used as the target.

### <Testing Example 1> (Measurement of Number of Holes)

For the surface on the metal layer side in the laminate of the base material and metal layer formed in each of Example and Comparative Examples, a scanning electron microscope (SEM) was used to capture an SEM image of an any area of 150 μm×220 μm on the metal layer surface at a magnification of ×1000.

For the obtained SEM image, image analysis software “ImageJ” was used to calculate the area of each hole present in the metal layer surface. In the SEM image, the hole portions appear darker than their surroundings, so the dark and light portions were binarized, and the area of a dark portion was calculated to determine the area of the hole.

Then, the number of holes with an area of 0.5 μm² or more (the number in an area of 150 μm×220 μm) was counted. The results are listed in Table 1. It can be found from Table 1 that holes with an area of 0.5 μm² or more were confirmed in Example 1, but not in Comparative Example 1 or Comparative Example 2.

For Example 1 in which the presence of the holes with an area of 0.5 μm² or more was confirmed, Table 2 lists the minimum and maximum values of the areas of the holes.

### <Testing Example 2> (Measurement of Distance Between Two Adjacent Holes)

In the SEM image of Example 1 obtained in Testing Example 1, the distance between two adjacent holes was measured for all holes that satisfied the condition that the area was 0.5 μm² or more.

Specifically, first, when the number of holes to be measured was n (n: integer, n≥2), any one of the n holes was selected and defined as a first hole. Then, a distance (A1-1) between the first hole and a hole closest to the first hole and a distance (A1-2) between the first hole and a hole second closest to the first hole were measured. Next, any one hole other than the aforementioned first hole among the n holes was selected and defined as a second hole. Then, after excluding between the holes that had already been measured, a distance (A2-1) between the second hole and a hole closest to the second hole and a distance (A2-2) between the second hole and a hole second closest to the second hole were measured. This operation was performed for n holes (A1-1, A1-2, A2-1, A2-2, . . . , An-1, An-2). Note that the distance between holes refers to the distance between the centroid points of the holes.

That is, in the case of Example 1, the above operation was performed for 11 holes. The average value and minimum and maximum values of the obtained distance (μm) between two adjacent holes are listed in Table 2.

### <Testing Example 3> (Measurement of Radius of Perfect Circle Passing Through Three Adjacent Holes)

In the SEM image of Example 1 obtained in Testing Example 1, the radius of a perfect circle passing through three adjacent holes was measured for all holes that satisfied the condition that the area was 0.5 μm² or more.

Specifically, first, when the number of holes to be measured was n (n: integer, n≥3), any one of the n holes was selected and defined as a first hole. Then, “a perfect circle passing through the first hole, a hole closest to the first hole, and a hole second closest to the first hole” was defined as a first perfect circle, and a radius (B1) of the first perfect circle was measured. Next, any one hole among the n holes excluding the aforementioned first hole was selected and defined as a second hole. Then, after excluding the perfect circle that had already been measured, “a perfect circle passing through the second hole, a hole closest to the second hole, and a hole second closest to the second hole” was defined as a second perfect circle, and a radius (B2) of the second perfect circle was measured. This operation was performed for n holes (B1, B2, . . . , Bn). Note that the perfect circle passes through the centroid point of each hole.

That is, in the case of Example 1, the above operation was performed for 11 holes. The average value and minimum and maximum values of the obtained radius (μm) of a perfect circle passing through three adjacent holes are listed in Table 2.

### <Testing Example 4> (Measurement of Distance Between Centroid of First Triangle and Centroid of Second Triangle)

In the SEM image of Example 1 obtained in Testing Example 1, the distance between the centroid of the first triangle and the centroid of the second triangle was measured for all holes that satisfied the condition that the area was 0.5 μm² or more.

Specifically, first, when the number of holes to be measured was n (n: integer, n≥4), any one of the n holes was selected and defined as a first hole. Then, “a triangle with vertices of the first hole, a hole closest to the first hole, and a hole second closest to the first hole” was defined as a first triangle. Out of “a triangle with vertices of the first hole, the hole closest to the first hole, and a hole third closest to the first hole” and “a triangle with vertices of the first hole, the hole second closest to the first hole, and the hole third closest to the first hole,” one having a smaller area was defined as a second triangle. If the areas were the same, the former was defined as the second triangle. Then, a distance (C1) between the centroid point of the first triangle and the centroid point of the second triangle was measured. Next, any one hole among the n holes excluding the aforementioned first hole was selected and defined as a second hole. Then, after excluding the distance already measured between the centroid point of the first triangle and the centroid point of the second triangle, a distance (C2) between the centroid point of a first triangle and the centroid point of a second triangle that were obtained using the second hole as a starting point was measured like the distance (C1). This operation was performed for n holes (C1, C2, . . . , Cn). Note that each vertex of a triangle is the centroid point of each hole.

That is, in the case of Example 1, the above operation was performed for 11 holes. The average value and minimum and maximum values of the obtained distance (μm) between the centroid point of the first triangle and the centroid point of the second triangle are listed in Table 2.

### <Testing Example 5> (Measurement of Distance Between Center of First Perfect Circle and Center of Second Perfect Circle)

in the SEM image of Example 1 obtained in Testing Example 1, the distance between the center of the first perfect circle and the center of the second perfect circle was measured for all holes that satisfied the condition that the area was 0.5 μm² or more.

Specifically, first, when the number of holes to be measured was n (n: integer, n≥4), any one of the n holes was selected and defined as a first hole. Then, “a perfect circle passing through the first hole, a hole closest to the first hole, and a hole second closest to the first hole” was defined as a first perfect circle. For a hole that was not concentric with the first perfect circle and was third closest to the first hole, out of “a perfect circle passing through the first hole, the hole closest to the first hole, and the hole third closest to the first hole” and “a perfect circle passing through the first hole, the hole second closest to the first hole, and the hole third closest to the first hole,” one having a smaller area was defined as a second perfect circle. If the areas were the same, the former was defined as the second perfect circle. Then, a distance (D1) between the center of the first perfect circle and the center of the second perfect circle was measured. Next, any one hole among the n holes excluding the aforementioned first hole was selected and defined as a second hole. Then, after the distance already measured between the center of the first perfect circle and the center of the second perfect circle was excluded, a distance (D2) between the center of a first perfect circle and the center of a second perfect circle that were obtained using the second hole as a starting point was measured in the same manner as above. The operation was performed for the n distances (D1, D2, . . . , Dn). The perfect circle passes through the centroid point of each hole.

That is, in the case of Example 1, the above operation was performed for 11 holes, and the distance (μm) between the center of the first perfect circle and the center of the second perfect circle was obtained. The average value and minimum and maximum values are listed in Table 2.

### <Testing Example 6> (Measurement of Water Vapor Transmission Rate)

For the laminate of the base material and metal layer formed in each of Example and Comparative Examples, the water vapor transmission rate was measured according to JIS Z0208-1976. Specifically, after a 50 μm-thick unstretched polypropylene film was dry-laminated on the surface of the above laminate on the metal layer side, two test pieces measuring 10 cm×10 cm were cut out. Then, about 20 g of anhydrous calcium chloride as a moisture absorbent was interposed between the two test pieces, and in this state the four sides were sealed. The test bag thus obtained was placed in a thermo-hygrostat at a temperature of 40° C. and a relative humidity of 90%, and the mass was measured (in 0.1 mg units) for up to 30 days as a guideline for the rate of mass increase to become almost constant. Thus, the water vapor transmission rate (g/m²·day) was calculated. The results are listed in Table 1.

### <Testing Example 7> (Evaluation of Water Drainage Properties)

A detergent (available from Johnson & Johnson, “Baby Moisture Whole Body Shampoo”) was diluted with pure water to a concentration of 0.5% to obtain an application liquid. Then, the release sheet was removed from the laminated sheet manufactured in each of Example and Comparative Examples, and the above application liquid was sprayed onto the exposed surface of the pressure sensitive adhesive layer. After that, the exposed surface of the pressure sensitive adhesive layer was attached to a glass plate, and the application liquid was scraped off from the edge portion of the laminated sheet using a rubber squeegee. After leaving it for three days, the presence or absence of remaining application liquid between the laminated sheet and the window glass was visually confirmed, and the water drainage properties were evaluated based on the following criteria. The results are listed in Table 1.
◯: No remaining application liquid.
X: Some remaining application liquid was present.

TABLE 1

| | | | Number | | |
|---|---|---|---|---|---|
| | | Film | of holes | Water vapor | Water |
| | [symbol] Type | formation | with area of | transmission | drainage |
| | of metal [symbol] | method | 0.5 μm [symbol] or more | rate (g/m [symbol] · day) | properties |
| Example 1 | Nickel | Electron [symbol] | 11 | 28.5 | ∘ |
| | | vapor deposition | | | |
| | | method | | | |
| Comparative | Nichrome | Sputtering | 0 | 2.5 | x |
| Example 1 | | method | | | |
| Comparative | Nickel | Sputtering | 0 | [symbol] .0 | x |
| Example 2 | | method | | | |

[symbol]

indicates data missing or illegible when filed

TABLE 2

| | Average | Minimum | Maximum |
|---|---|---|---|
| | value | value | value |
| Area of holes (μm) | 1. [symbol] 7 | 0.91 | 2.67 |
| (A) Distance between two adjacent holes (μm) | 44. [symbol] | 17. [symbol] | 87. [symbol] |
| (B) Radius of perfect circle passing through three adjacent holes (μm) | 44.7 | 1 [symbol] | [symbol] |
| (C) Distance between centroid of first triangle and centroid of second triangle (μm) | 25.1 | 12.2 | 41.2 |
| (D) Distance between center of first triangle and center of second triangle (μm) | 10 [symbol] .2 | 6.7 | [symbol] |

[symbol]

indicates data missing or illegible when filed

As can be seen from Table 1, it has been found that the laminated sheet obtained in Example is excellent in the water vapor transmission properties and exhibits satisfactory water drainage properties.

### INDUSTRIAL APPLICABILITY

The laminated sheet of the present invention can be suitably used as a window film, etc.

### DESCRIPTION OF REFERENCE NUMERALS

10a, 10b, 10c, 10d . . . Laminated sheet
1 . . . Base material
2 . . . Metal layer
3 . . . Pressure sensitive adhesive layer
4 . . . Hard coat layer
5 . . . Release sheet

1. A laminated sheet comprising a base material and a metal layer provided on one surface side of the base material,
wherein one or more holes having an area of 0.5 μm² or more when viewed in a plan view are present in the metal layer.

2. The laminated sheet according to claim 1, wherein the area is 10 μm² or less.

3. The laminated sheet according to claim 1, wherein the one or more holes have an irregular shape when viewed in the plan view.

4. The laminated sheet according to claim 1, wherein the number of the one or more holes is one or more per an area of 150 μm×220 μm of the metal layer.

5. The laminated sheet according to claim 1, wherein
two or more of the holes are present in the metal layer,
and
an average value of a distance between adjacent two of the holes is 1 μm or more and 200 μm or less.

6. The laminated sheet according to claim 1, wherein
three or more of the holes are present in the metal layer, and
an average value of a radius of a perfect circle passing through adjacent three of the holes is 1 μm or more and 100 μm or less.

7. The laminated sheet according to claim 1, wherein
provided that:
the number of the one or more holes present in the metal layer is n (n: integer, n≥4);
any one of the n holes is selected and defined as a first hole;
a triangle with vertices of the first hole, a hole closest to the first hole, and a hole second closest to the first hole is defined as a first triangle; and
out of a triangle with vertices of the first hole, the hole closest to the first hole, and a hole third closest to the first hole and a triangle with vertices of the first hole, the hole second closest to the first hole, and the hole third closest to the first hole, one having a smaller area is defined as a second triangle,
when:
a distance (C1) between a centroid point of the first triangle and a centroid point of the second triangle is measured;
then, any one hole among the n holes excluding the first hole is selected and defined as a second hole, and after the distance already measured between the centroid point of the first triangle and the centroid point of the second triangle is excluded, a distance (C2) between a centroid point of a first triangle and a centroid point of a second triangle that are obtained using the second hole as a starting point is measured like the distance (C1); and
the measurement is further performed for the n distances (C1, C2, . . . , Cn), an average value of the n distances (C1, C2, . . . , Cn) is 1 μm or more and 100 μm or less.

8. The laminated sheet according to claim 1, wherein
provided that:
the number of the one or more holes present in the metal layer is n (n: integer, n≥4);
any one of the n holes is selected and defined as a first hole;
a perfect circle passing through the first hole, a hole closest to the first hole, and a hole second closest to the first hole is defined as a first perfect circle; and
for a hole that is not concentric with the first perfect circle and is third closest to the first hole, out of a perfect circle passing through the first hole, the hole closest to the first hole, and the hole third closest to the first hole and a perfect circle passing through the first hole, the hole second closest to the first hole, and the hole third closest to the first hole, one having a smaller area is defined as a second perfect circle,
when:
a distance (D1) between a center of the first perfect circle and a center of the second perfect circle is measured;
then, any one hole among the n holes excluding the first hole is selected and defined as a second hole, and after the distance already measured between the center of the first perfect circle and the center of the second perfect circle is excluded, a distance (D2) between a center of a first perfect circle and a center of a second perfect circle that are obtained using the second hole as a starting point is measured like the distance (D1); and
the measurement is further performed for the n distances (D1, D2, . . . , Dn), an average value of the n distances (D1, D2, . . . , Dn) is 1 μm or more and 400 μm or less.

9. The laminated sheet according to claim 1, wherein the laminated sheet includes a pressure sensitive adhesive layer.

10. The laminated sheet according to claim 1, wherein the laminated sheet is a window film.

11. A method of manufacturing the laminated sheet according to claim 1, comprising:
irradiating a metal with an electron beam to vaporize the metal; and
depositing the vaporized metal on one surface side of the base material to form the metal film.
